(19) United States
(12) Patent Application Publication
(10) Pub. No.: US 2024/0052107 A1
(43) Pub. Date: Feb. 15, 2024

(54) PRODUCTION OF ALKOXYSILOXANES

(71) Applicant: Evonik Operations GmbH, Essen (DE)

(72) Inventors: Wilfried KNOTT, Essen (DE); Horst DUDZIK, Essen (DE); Frauke HENNING, Essen (DE)

(73) Assignee: Evonik Operations GmbH, Essen (DE)

(21) Appl. No.: 18/447,558

(22) Filed: Aug. 10, 2023

(30) Foreign Application Priority Data
Aug. 12, 2022 (EP) 22190106.9

(51) Int. Cl. C08G 77/14; C08G 77/38

(52) U.S. Cl. CPC C08G 77/14; C08G 77/38

(57) ABSTRACT

Processes may produce alkoxysiloxane(s) by reaction of siloxane parent structure(s) with alkali metal alkoxide(s). Such processes may include reacting siloxane parent structure(s) by mixing with alkali metal alkoxide(s) with heating and optionally adding silicon dioxide, but without adding alcohol and without removal of any potentially occurring water from the reaction mixture; and neutralizing the resulting reaction mixture by adding Brønsted acid(s), optionally solvent(s), and preferably separating solid constituents; and subsequently isolating the alkoxysiloxane(s) by thermally separating volatile compounds. The siloxane parent structure(s) may be a hexamethylcyclotrisiloxane (D₃), octamethylcyclotetrasiloxane (D₄), decamethylcyclopentasiloxane (D₅), dodecamethylcyclohexasiloxane (D₆), mixture of cyclic branched D/T type siloxanes, silicone oils preferably including at least 100 D units, polydimethylsiloxanediol(s), and/or α,ω-divinylsiloxane(s).

The invention is in the field of silicones. It relates in particular to a process for producing one or more alkoxysiloxanes by reaction of at least one siloxane parent structure with at least one alkali metal alkoxide, optionally with addition of silicon dioxide. It further relates to alkoxysiloxanes obtainable by such a process and to the use of such alkoxysiloxanes.

Alkoxysiloxanes are siloxanes comprising one or more, preferably two, alkoxy groups. Linear α,ω-dialkylsiloxanes are particularly preferred alkoxysiloxanes in the context of the present invention, with linear α,ω-dialkoxypolydimethylsiloxane being very particularly preferred.

Methods for producing alkoxysiloxanes are known. Various methods describing the substitution of silicon-bonded, reactive groups by alkoxy radicals are referenced in particular. These, in some cases very old, synthetic routes proceed via the substitution of chlorine and/or hydrogen (dehydrogenative route) and we refer, as a reference elucidating the preparative options, to W. Noll, Chemie and Technologie der Silicone, Verlag Chemie GmbH, Weinheim, (1960), pages 60-61, which discusses the conversion of groups that are reactive but bonded to the silanic silicon into alkoxysilanes.

By contrast, a markedly smaller number of works are concerned with routes to alkoxysiloxanes starting from non-functional siloxanes.

In U.S. Pat. No. 2,881,199 Bailey et al. claim the production of alkoxy-bearing silanes and also alkoxy-bearing di- and trisiloxanes by acid-catalyzed reaction of cyclic siloxanes with alcohols under reflux conditions and with continuous, azeotropic removal of the water formed during the reaction. As a consequence of the acidic reaction conditions the authors expect the very slow reactions (24 hours) to additionally result in an undesired etherification reaction of the employed alcohol.

Also under acid catalysis Zhurkina et al. (Zh. Obshch. Khim. 1989, 59, 1203-1204) react ethyl orthoformate esters with octamethylcyclotetrasiloxane under mild conditions (16-20° C.) to afford a diethoxyoctamethyltetrasiloxane-containing reaction mixture and isolate the siloxane by subsequent vacuum distillation. The extent to which the use of ethyl orthoformate esters as an exotic water scavenging reagent allows acceptable yields is not referenced, though it is indicated that ethyl orthoformate does not react under these conditions.

Base-catalyzed siloxane rearrangements are also known.

Accordingly, the teaching of U.S. Pat. No. 3,477,988 is directed to the base-catalyzed rearrangement of siloxanes in the presence of organophosphorus compounds such as in particular hexamethylphosphoric triamide and even includes the utilization of relatively high molecular weight hydrolyzates, rubbers and elastomers. The need to employ aprotic polar solvents such as the carcinogenic hexamethylphosphoric triamide is a barrier to the use of the teaching in industry.

Chang et al. (J. Polym. Res. 2005, 12, 433-438) report the nucleophilic cleavage of crosslinked polysiloxanes to obtain cyclic siloxane monomers which comprised initially swelling a crosslinked, filled polydimethylsiloxane 4 or 5 volumes of tetrahydrofuran, toluene or diethylamine at room temperature overnight and subsequently dissolving the thus-swollen samples with separately prepared homogeneous solutions of potassium hydroxide in dimethylamine with stirring at room temperature. In periods of 0.4 to 4 hours the authors observed complete dissolution of the silicone rubber constituents. The yields of cyclic products determined after 25 hours reaction time were in the range from 10% by weight to 77% by weight, wherein the yield of the dissolution experiment performed in diethylamine exceeded the yields determined for the experiments run in tetrahydrofuran, tetrahydrofuran/toluene and toluene.

IN K' o Hsueh Tung Pao, 1959, 3, 92-93 Wang und Lin report the decomposition of polyorganosiloxanes by butanolysis, wherein sodium hydroxide is employed as a cleavage reagent and a butanol-water azeotrope is continuously discharged from the reaction system. The authors are unable to solve the dilemma of an alkali-induced polymerization proceeding in effective competition with the alkoxy functionalization which—since it is uncontrolled—produces both short-chain and long-chain cleavage products.

In Zh. Obshch. Khim.1959,29,1528-1534 (Russian Journal of General Chemistry 1959, 29, 1528-1534) Vornokov und Shabarova describe the production of organoalkoxysilanes by cleavage of organosiloxanes with C₄-to C₁₂-alcohols under basic conditions, wherein alkali metal hydroxides, alkali metal alkoxides or the alkali metals themselves are employed.

The authors interpreted the reaction of the organosiloxane with alcohol as an equilibrium reaction where it is important to remove water of reaction from the reaction system azeotropically or using an inert, water-insoluble solvent or else preferably by addition of silicic esters (tetralkoxysilanes) as dehydrating agents. Neither the production of alkoxysilanes derivable from alcohols having boiling points below 90° C. nor the attainment of high yields of alkoxysilanes are possible without the use of dehydrating reagents.

By contrast, the publication does not provide a solution for the production of alkoxysiloxanes since, as is understood by those skilled in the art, especially any remaining high-boiling tetraalkoxysilanes (for example tetraethoxysilane b.p. 168° C.) and the condensation products resulting therefrom would entail considerable separation and purification effort.

Petrus et al. report the solvothermal alcoholysis of crosslinked silicone rubber wastes (Macromolecules 2021, 54, 2449-2465) and describe inter alia the dissolution of shredded silicone rubber in a high-pressure reactor using n-octanol in the temperature range between 180° C. and 240° C. and over reaction times between 16 and 18 hours.

The conversions of the reaction are reported as in the range from 22% to 80% and analysis demonstrates that alkoxyoligosiloxanes were formed. To interpret the initially surprising finding that a crosslinked siloxane is apparently amenable to uncatalyzed alcoholysis, Petrus et al. assume that the high digestion temperatures above 200° C. in conjunction with moisture liberate acid traces from the peroxidically crosslinked silicone rubber, which then catalyze the cleavage of the Si—O—Si bonds.

In order to try to perform said alcoholysis reaction more effectively, i.e. over shorter reaction times, at reduced temperatures and also at lower catalyst loadings, Petrus et al. (ibid.) employ alkali metal aryl oxides aided by the methylsalicylato ligand, and magnesium and zinc aryl oxides and mixed metal aryl oxides with methylsalicylato ligands as catalyst. The best complex in this investigation was found to be the magnesium-sodium-potassium aryl oxide [Mg₂M′₂ (MesalO)₆(THF)₄], where M′=Na, K and MesalO is the methylsalicylato ligand, which allows production of dioctanoxydimethylsilane and 1,3-dioctanoxy-1,1,3,3-tetramethyldisiloxane in yields of 79% and 17% respectively over 2 hours at a reaction temperature of 220° C.

Furthermore, Okamoto et al. in Appl. Catalysis A: General 261 (2004), 239-245 describe the depolymerization of polysiloxanes and of SiO₂-filled silicone rubber with dimethyl carbonate and methanol to afford methyl trimethylsilane and dimethoxy dimethylsilane and liberate carbon dioxide, wherein not only alkali metal halides but also potassium hydroxide and potassium methoxide are used as catalysts. Performing the process requires an autoclave since the depolymerization is performed at 180° C. over a period of 15 hours. When using solely methanol or dimethyl carbonate only 2 to 3 percent depolymerization are achieved. The authors conclude from their experiments that both dimethyl carbonate and methanol must be added to depolymerize polysiloxanes. The need for both a pressure resistant apparatus and a complex digestion system, as well as lengthy reaction times at high temperature, make this route unattractive for an industrial reaction.

In light of all of these efforts, the technical problem to be solved is defined as that of finding a practicable and preferably timesaving and very simple synthetic route to alkoxysiloxanes starting from siloxane parent structures which can forego complex chemical systems such as in particular multicomponent solvent mixtures and exotic catalysts and ideally also specialized apparatuses.

Cited as a reference in relation to the M, D, T, Q nomenclature used in the context of this document to describe the structural units of organopolysiloxanes is W. Noll, Chemie and Technologie der Silicone [Chemistry and Technology of the Silicones], Verlag Chemie GmbH, Weinheim (1960), page 2 ff.

In the context of the present invention the term “siloxane parent structures” is in particular to be understood as meaning siloxanes constructed predominantly from D units, preferably for example siloxane cycles such as hexamethylcyclotrisiloxane (D₃), octamethylcyclotetrasiloxane (D₄), decamethylcyclopentasiloxane (D₅), dodecamethylcyclohexasiloxane (D₆) and/or any desired mixtures thereof.

In the context of the present invention the term “siloxane parent structures” is likewise to be understood as encompassing mixtures of cyclic branched siloxanes of the D/T type, preferably produced as described in EP 3321304 A1, EP 3401353 A1 or EP 3467006 A1, which preferably in admixture with siloxane cycles, for example octamethylcyclotetrasiloxane (D₄), decamethylcyclopentasiloxane (D₅) and/or dodecamethylcyclohexasiloxane (D₆), can generate branched alkoxy-bearing siloxanes after processing according to the invention.

Cyclic branched siloxanes of the D/T type are cyclic siloxanes constructed from D- and T-units. Mixtures of cyclic branched siloxanes of the D/T type are accordingly cyclic siloxanes constructed from D- and T-units.

EP 3401353 A1 describes mixtures of cyclic branched siloxanes comprising D and T units and a process for production thereof, comprising (a) an acid-catalysed equilibration of trialkoxysilanes with siloxane cycles and/or α□ω-dihydroxypolydimethylsiloxane in the presence of at least one acidic catalyst and then (b) a hydrolysis and condensation reaction initiated by water addition, and addition of a silicon-containing solvent, followed by (c) distillative removal of the liberated alcohol, of water present in the system and of silicon-containing solvent and neutralization or removal of the acidic catalyst and optionally removal of any salts that may have formed, wherein the silicon-containing solvent preferably comprises the isomeric siloxane cycles octamethylcyclotetrasiloxane (D₄), decamethylcyclotetrasiloxane (D₅) and/or mixtures thereof and mass ratios of silicon-containing solvent to the siloxane comprising D and T units of 1:1 to 5:1 are advantageously employed.

EP 3 321 304 A1 describes mixtures of cyclic-branched siloxanes comprising D and T units and a process for production thereof, wherein a trialkoxysilane is reacted with siloxane cycles and/or α,ω-dihydroxypolydimethylsiloxane in a solvent with addition of water and in the presence of at least one acidic catalyst.

EP 3 467 006 A1 describes mixtures of cyclic branched siloxanes comprising D and T units and a process for production thereof comprising
(a) an acid-catalysed equilibration of trialkoxysilanes with siloxane cycles and/or α□ω-dihydroxypolydimethylsiloxane in the presence of at least one acidic catalyst and then
(b) a hydrolysis and condensation reaction initiated by water addition followed by addition of a silicon-containing solvent,
(c) with subsequent distillative removal of the liberated alcohol and proportions of the water present in the system,
(d) with subsequent addition of toluene and continuous discharging of residual water remaining in the system,
(e) followed by neutralization or removal of the acidic catalyst and optionally removal of any salts that may have formed,
(f) with subsequent distillative removal of toluene remaining in the system, wherein the silicon-containing solvent preferably comprises the isomeric siloxane cycles octamethylcyclotetrasiloxane (D₄), decamethylcyclopentasiloxane (D₅) and/or mixtures thereof and mass ratios of silicon-containing solvent to the siloxane comprising D and T units of 1:1 to 5:1 are advantageously employed.

In the context of the present invention the term “siloxane parent structures” is in particular also to be understood as meaning silicone oils preferably comprising at least 100 D units, polydimethylsiloxanediols and α,ω-divinylsiloxanes, wherein the use of silicone oils orα,ω-divinylsiloxanes is less preferred since—depending on their respective average chain length—they may introduce a proportion of trimethylsilyl groups or vinyldimethylsilyl groups into the reaction system.

It has surprisingly been found that the described problem of producing alkoxysiloxanes is solved by the subject matter of the invention.

The subject matter of the invention is a process for producing one or more alkoxysiloxanes by reaction of at least one siloxane parent structure with at least one alkali metal alkoxide, wherein the process comprises
(a) a first step of reacting at least one siloxane parent structure by mixing with at least one alkali metal alkoxide with heating and optionally with addition of silicon dioxide but without addition of alcohol and without removal of any potentially occurring water from the reaction mixture and
(b) a second step of neutralizing the reaction mixture resulting from step (a) by addition of at least one Brønsted acid, optionally with addition of at least one solvent, and preferably separating solid constituents and
(c) subsequently isolating the alkoxysiloxane(s) by thermal separation of volatile compounds, wherein the at least one siloxane parent structure is selected from the group consisting of hexamethylcyclotrisiloxane (D₃), octamethylcyclotetrasiloxane (D₄), decamethylcyclopentasiloxane (D₅), dodecamethylcyclohexasiloxane (D₆), mixtures of cyclic branched siloxanes of the D/T type, silicone oils (preferably silicone oils comprising at least 100 D units), polydimethylsiloxanediols and α,ω-divinylsiloxanes.

According to the invention at least one siloxane parent structure is employed, i.e. one or more of the siloxane parent structures mentioned in claim 1 may be employed. It is thus also possible to employ any desired mixtures of the abovementioned siloxane parent structures.

The finding that it is possible to convert for example decamethylcyclopentasiloxane into a linear α,ω-dimethoxypolydimethylsiloxane in the course of only 4 hours by treatment with solid potassium methoxide at 120° C. in the absence of both dimethyl carbonate and methanol is entirely surprising and unpredictable in light of the findings of Okamoto. Okamoto demonstrates not only the need to employ a chemically complex depolymerization system but also that the depolymerization rate does not depend on the catalyst and concludes therefrom that the catalyst itself is not involved in the rate-determining step.

While the publication of Okamoto et al. attributes the role of a catalyst of limited efficacy to the sodium methoxide also employed therein in addition to other salts, in the present process according to the invention the alkali metal alkoxide appears to be the key reagent effecting the alkoxy modification.

Surprisingly, and thus also in a complete departure from the teaching of Vornokov (see above), the process according to the invention for producing alkoxysiloxanes also eschews any water-incompatible solvents as azeotrope-formers, let alone dehydrating substances such as for example silicic esters (tetraalkoxysilanes). The reaction according to the invention in the first step (a) is carried out without removal of any occurring water from the reaction mixture and without addition of alcohol.

The reaction in step (a) may therefore be undertaken without the use of solvents forming azeotropes with water and/or without the use of water-binding silicic esters, in particular without the use of tetraalkoxysiloxanes, which corresponds to a preferred embodiment of the invention.

In particular the reaction in step (a) may be performed solventlessly, which likewise corresponds to a preferred embodiment of the invention.

In the first step (a) of the present invention the siloxane parent structure is reacted with at least one alkali metal alkoxide.

The inventors have found in numerous experiments that among the alkali metal alkoxides employable according to the invention the methoxides (M⁺OCH₃⁻) of potassium and of sodium are particularly preferred since in the reaction with siloxane parent structures, such as for example decamethylcyclopentasiloxane, they even react selectively to afford linear alkoxysiloxanes whose accompanying ²⁹Si-NMR spectra contain no ≡SiOH signals. The use of potassium and/or sodium methoxide is therefore very particularly preferred. This corresponds to a preferred embodiment of the invention.

By contrast, if potassium or sodium ethoxide is reacted with decamethylcyclopentasiloxane the ²⁹Si-NMR spectra of the obtained products exhibit pronounced ≡SiOH signals adjacent to the ≡SiOC₂H₅ signals (example 2).

It has further surprisingly been found that the addition of a pulverulent silicon dioxide (such as in particular pyrogenic silicon dioxide, known as Aerosil® for example, or else precipitated silicon dioxide) to these aforementioned ethoxide systems in the first step (a) as is preferred can improve selectivity to such an extent that only ≡SiOC₂H₅ signals remain detectable in the ²⁹Si-NMR spectrum (example 3).

However, the inventors have observed that the addition of other pulverulent silicates does not have a positive effect on this selectivity (see for example perlite addition, example 4).

The observation that addition of a pulverulent silicon dioxide (for example Aerosil®, example 3) to the ethoxide systems can improve selectivity to such an extent that only ≡SiOC₂H₅ signals and no ≡SiOH signals remain observable in the ²⁹Si-NMR spectrum is confounding.

In the context of the present invention the term “pulverulent silicon dioxide” is to be understood as meaning in particular synthetically produced pulverulent silicon dioxides (so-called precipitated silicon dioxide) and the pyrogenic silicon dioxides. These silicon dioxides known to those skilled in the art are pulverulent.

It therefore corresponds to a preferred embodiment of the invention when in the process according to the invention the reaction in the first step (a) is carried out in the presence of pulverulent silicon dioxide, preferably in the presence of pyrogenic silicon dioxide and/or precipitated silicon dioxide.

As is apparent from the foregoing, in respect of the first process step (a) the following two particularly preferred embodiments (i) and (ii) are very particularly advantageous: namely when in the first step (a) the siloxane parent structure(s) are reacted by mixing with potassium and/or sodium methoxide with heating according to particularly preferred embodiment (i) or when in step (a) the siloxane parent structure(s) are reacted by mixing with potassium and/or sodium ethoxide in the presence of pulverulent silicon dioxide and with heating according to particularly preferred embodiment (ii).

Preferably employable pyrogenic silicon dioxides have specific surface areas of 50 to 600 m²/g. Preferably employable precipitated silicon dioxide has specific surface areas of 20 to 800 m²/g. The specific surface area expressed as the BET surface area is measured by means of nitrogen (0-BET-N₂) at the boiling temperature of the liquid nitrogen, preferably according to ISO 9277:2010-09, “Determination of the specific surface area of solids by gas adsorption—BET method”.

In the context of the present invention “alkali metal alkoxide” is preferably to be understood as meaning compounds of general formula:

[M⁺][OR⁻],

wherein
M is selected from the group of alkali metals Li, Na or K, preferably Na or K, and
R represents a linear, branched or cyclic alkyl radical, preferably having 1 to 10 carbon atoms, particularly preferably having 1 to 6 carbon atoms, very particularly preferably having 1 or 2 carbon atoms. According to the invention, at least one alkali metal alkoxide is employed. It is thus possible to employ one or more alkali metal alkoxides. The use of the potassium ethoxide, sodium ethoxide, potassium methoxide and/or sodium methoxide is most preferred.

The known processes for producing alkoxides include chloralkali electrolysis by the amalgam process where sodium amalgam is reacted with alcohol [cf. for example Chemical and Engineering News 22, 1903-06 (1944)].

A further known method is the production of alkoxides from an alkali metal and an alcohol or from an alkali metal hydroxide and an alcohol. Alkoxide production from an alkali metal and a tertiary alcohol is known for example from DE-23 33 634 (Dynamit Nobel) or DE 26 12 642 (Degussa). Production of an alkoxide from an alkali metal hydroxide and a tertiary alcohol is likewise known. The first process variant requires the use of costly alkali metal and the second variant proceeding from alkali metal hydroxide requires that the water formed during the reaction be removed by distillation, thus necessitating correspondingly high thermal outlay.

According to the teaching of DE-A-33 46 131 alkali metal alkoxides are produced from salts by electrolysis and employ an electrolysis cell where a cation exchange membrane separates the electrode spaces. DE-42 33 191.9-43 describes a process which allows production of an alkali metal alkoxide from a salt by electrodialysis.

Also described individually are processes for producing specialty alkoxides, for example the alkoxides of higher and/or polyhydric alcohols. Alkoxides of higher and/or polyhydric alcohols are known to be producible in principle by transalcoholization, i.e. by substitution of the alkoxide radical of lower alkoxides ROM by reaction with higher alcohols R′OH (wherein R and R′ are alkyl radicals of different carbon chain lengths and M represents a metal cation) in a liquid reaction mixture at suitable temperature and pressure conditions. In the laboratory jargon this reaction substituting the alkoxide radical is referred to as “recooking”. The position of the equilibrium ROM+R′OH⇔ROH+R′Om depends on the acidity of the two alcohols which decreases according to the sequence methanol>primary>secondary>tertiary alcohols [R. T. McIver and J. A. Scott, J. American Chem. Soc. 96 (1973) 2706]. Accordingly, it is said that production of the alkoxides of secondary alcohols in this way is possible only in exceptional cases and the production of alkoxides of tertiary alcohols by transalcoholization is entirely unsuccessful [“Methoden der Organischen Chemie” (1963) Bd. 6/2, S. 13]. However, DE-1 254 612 and DE-27 26 491 (both Dynamit Nobel) disclose production of alkoxides by reboiling for higher alcohols too. GB-1 143 897 (Metallgesellschaft) describes the reaction of a monovalent alkali metal alkoxide with a C₂-to C₁₈ alcohol or phenol containing up to six hydroxyl groups, wherein the an excess of monohdyric alcohol and/or a hydrocarbon is employed as solvent. However, the recooking always leads to formation of the low-boiling alcohol ROH (for example methanol) which requires removal from the reaction product mixture in some cases with considerable thermal outlay and optionally in addition to the unconverted higher alcohol R′OH for isolation of the desired alkoxide.

Apart from these thermal equilibrium shifts, EP 0776995 B1 also teaches a process for producing alkoxides under the influence of an electric field, wherein an alcohol is converted into the desired alkoxide by supplying metal ions and the metal ions themselves derive from the electrochemical decomposition of another alkoxide in the electric field. The alkoxide formation and decomposition are carried out in chambers spatially separated by ion exchange membranes.

According to the invention at least one siloxane parent structure is reacted with at least one alkali metal oxide optionally in the presence of pulverulent silicon dioxide with heating and with mixing of the reaction batch. The heating may be realized in the usual manner known to those skilled in the art, on a laboratory scale for example through the use of so-called heating baths or heating mantles and on a larger scale for example through the use of double-walled heatable reactors. Preferred reaction temperatures are specified hereinbelow and are preferably in the range from 100° C. to 200° C. The mixing may likewise be realized in the usual manner known to those skilled in the art, for example by stirring using customary mixing apparatuses.

According to the invention the reaction mixture resulting from this reaction step is neutralized by adding at least one Brønsted acid, optionally with addition of at least one solvent, and then solid constituents are separated, in particular by filtration, before thermal separation of volatile compounds and isolation of the desired alkoxysiloxane(s).

The at least one alkali metal alkoxide is preferably employed in total amounts of 1 to 10 mol %, preferably of 2 to 7 mol %, particularly preferably of 3 to 6 mol %, based on the total amount of the at least one siloxane parent structure. This corresponds to a preferred embodiment of the invention.

The optionally employable pulverulent silicon dioxide may preferably be employed in total amounts of 1 to 10 mol %, preferably of 2 to 8 mol %, particularly preferably of 4 to 7 mol %, based on the total amount of the at least one siloxane parent structure. This corresponds to a preferred embodiment of the invention.

It is preferable when the first step (a) of the process according to the invention is performed in the temperature range of 100° C. to 200° C., preferably in the temperature range of 120° C. to 160° C., and over a period of preferably 1 to 12 hours, preferably over a period of 2 to 8 hours, in each case preferably in the absence of solvent. This corresponds to a preferred embodiment of the invention.

If the inventive reaction of the at least one siloxane parent structure with at least one alkali metal alkoxide and optionally pulverulent silicon dioxide exhibits condensate formation, for example in a fitted reflux cooler, at standard pressure, i.e. at an external air pressure of 1013.25 hPa acting on the apparatus, it is preferable and advantageous for the achievable yield of alkoxysiloxanes to perform the reaction under superatmospheric pressure conditions in a pressure-resistant reactor, which corresponds to a preferred embodiment of the invention. The recorded pressure increase is autogeneous in nature and is attributable to the vapor pressure of the system components involved therein. If desired the reactor may optionally also be provided under an inert gas cushion.

According to the invention the reaction mixture resulting from the reaction with at least one alkali metal alkoxide is neutralized by addition of at least one Brønsted acid, optionally with addition of at least one solvent, in a second step (b).

At least one Brønsted acid is employed, i.e. one or more Brønsted acids may be employed. One or more anhydrous mineral acids (preferably anhydrous sulfuric acid and/or anhydrous perchloric acid) and/or one or more anhydrous organic acids (preferably anhydrous acetic acid) may preferably be used for neutralization. This corresponds to a preferred embodiment of the invention.

When using preferably anhydrous mineral acid(s) the addition amount is preferably chosen such that stoichiometric equivalence based on altogether employed alkali metal alkoxide is achieved. When using the markedly weaker anhydrous organic acids (for example anhydrous acetic acid) it is preferable to choose a marked stoichiometric excess of acid based on altogether employed alkali metal alkoxide. This is preferably up to a 50% excess.

The usage amount of the altogether employed Brønsted acid is thus preferably chosen such that it is in the range from stoichiometric equivalence to a 50% stoichiometric excess, in each case based on altogether employed alkali metal alkoxide.

If the amount of salt expected from the neutralization step according to the invention stands in the way of easy filtration it is preferable to provide for the use of at least one suitable solvent. One or more solvents may optionally be employed. Preferentially suitable optional solvents preferably include those which are themselves chemically inert with regard to the reaction system and which promote dilution/dispersion of the constituents of the neutralization step. It is preferable when the at least one optional solvent is selected from the group consisting of alkanes and alkylaromatics, wherein the use of alkylaromatics, such as preferably toluene and/or also the isomeric xylenes, is particularly preferable.

The solid constituents resulting from the neutralization step may preferably be separated, in particular by filtrative removal. Subsequently, especially after filtrative removal of the solid constituents resulting from the neutralization step, the volatile compounds are subjected to thermal separation and the alkoxysiloxane(s) are isolated.

The process according to the invention provides a simple route to the corresponding alkoxysiloxanes. The invention accordingly further provides alkoxysiloxanes produced by the process according to the invention.

The invention further provides for the use of the alkoxysiloxanes obtainable according to the invention as polymerization-active masses. Preference is given to the use of the alkoxysiloxanes obtainable according to the invention as adhesives and/or sealants optionally with addition of crosslinking catalysts and optionally blended with further crosslinking silanes and/or siloxanes and optionally employable fillers and/or pigments.

The alkoxysiloxanes are further also suitable for example as starting materials for producing SiOC-bonded polyethersiloxanes by transesterification with polyetherols in the presence of zinc acetylacetonate as catalyst, such as is disclosed in European patent application EP 3438158 (B1) for example. The present invention accordingly further provides for the use of alkoxysiloxanes obtainable according to the invention for producing SiOC-bonded polyethersiloxanes by transesterification of the alkoxysiloxanes with polyetherols in the presence of zinc acetylacetonate as catalyst.

If for example particular average siloxane chain lengths are desired prior to the further processing described here, the alkoxysiloxanes obtained according to the invention may optionally also be subjected to a preferably acid-catalyzed equilibration to establish the target chain lengths.

### EXAMPLES

The following examples serve only to explain this invention for those skilled in the art and do not constitute any restriction whatsoever of the claimed subject matter. ²⁹Si-NMR spectroscopy was used for reaction monitoring in all examples.

In the context of the present invention the ²⁹Si-NMR samples are analysed at a measurement frequency of 79.49 MHz in a Bruker Avance III spectrometer equipped with a 287430 sample head with gap width of 10 mm, dissolved at 22° C. in CDCl₃ and against a tetramethylsilane (TMS) external standard [δ(²⁹Si)=0.0 ppm].

Unless otherwise stated all percentages are to be understood as meaning weight percentages.

### Example 1 (Inventive)

In a 500 ml four-necked round bottom flask fitted with a KPG glass bladed stirrer and a reflux cooler 100 g of decamethylcyclopentasiloxane (D₅) were initially charged with stirring and admixed with 5 g of pulverulent potassium methoxide (KOCH₃, Evonik Industries).

The mixture was allowed to react at 120° C. over a period of 4 hours with further stirring. The batch was subsequently cooled to 60° C., admixed with 6.4 g of anhydrous acetic acid (50% excess) and stirred for 30 minutes at this temperature. 100 ml of toluene were added and the solids fractions were separated using a filter press (K 300 filter disc). The clear filtrate obtained is freed from volatiles on a rotary evaporator at a bath temperature of 70° C. and an applied vacuum of <5 mbar.

A sample of the thus obtained-colorless residue was analyzed by ²⁹Si-NMR spectroscopy. The characteristic signal positions of the accompanying ²⁹Si-NMR spectrum demonstrate that a linear α,ω-dimethoxypolydimethylsiloxane having an average chain length of about 48 was formed. The spectrum also indicates a small amount of T structures present (signal positions at −65 and −67 ppm)

### Example 2 (Inventive)

In a 500 ml four-necked round bottom flask fitted with a KPG glass bladed stirrer and a reflux cooler 100 g of decamethylcyclopentasiloxane (D₅) were initially charged with stirring and admixed with 5 g of pulverulent potassium ethoxide (KOC₂H₅, Evonik Industries).

The mixture was allowed to react at 120° C. over a period of 4 hours with further stirring. The batch was subsequently cooled to 60° C., admixed with 6.4 g of anhydrous acetic acid (50% excess) and stirred for 30 minutes at this temperature. 100 ml of toluene were added and the solids fractions were separated using a filter press (K 300 filter disc). The clear filtrate obtained is freed from volatiles on a rotary evaporator at a bath temperature of 70° C. and an applied vacuum of <5 mbar.

A sample of the thus obtained-colorless residue was analyzed by ²⁹Si-NMR spectroscopy. The characteristic signal positions of the accompanying ²⁹Si-NMR spectrum demonstrate that proportions of an SiOH-bearing siloxane were formed in addition to a linear α,ω-diethoxypolydimethylsiloxane.

### Example 3 (Inventive)

Analogously to the procedure described in example 2, in a 500 ml four-necked round bottom flask fitted with a KPG glass bladed stirrer and a reflux cooler 100 g of D₅ were initially charged with stirring and admixed with 5 g of pulverulent potassium ethoxide (KOC₂H₅, Evonik Industries) and with 5 g of Aerosil® 200 (Evonik Industries).

The mixture was allowed to react at 120° C. over a period of 4 hours with further stirring. The batch was subsequently cooled to 60° C., admixed with 6.4 g of anhydrous acetic acid (50% excess) and stirred for 30 minutes at this temperature. 100 ml of toluene were added and the solids fractions were separated using a filter press (K 300 filter disc). The clear filtrate obtained is freed from volatiles on a rotary evaporator at a bath temperature of 70° C. and an applied vacuum of <5 mbar.

A sample of the thus obtained-colorless residue was analyzed by ²⁹Si-NMR spectroscopy. The characteristic signal positions of the accompanying ²⁹Si-NMR spectrum demonstrate that a linear α,ω-diethoxypolydimethylsiloxane having an average chain length of about 48 was formed. The spectrum gives no indication of the presence of ≡Si—OH groups.

### Example 4 (Inventive)

Analogously to the procedure described in example 3, in a 500 ml four-necked round bottom flask fitted with a KPG glass bladed stirrer and a reflux cooler 100 g of decamethylcyclopentasiloxane (D₅) were initially charged with stirring and admixed with 5 g of pulverulent potassium ethoxide (KOC₂H₅, Evonik Industries) and with 5 g of Perlite D14 (Knauf).

The mixture was allowed to react at 120° C. over a period of 4 hours with further stirring. The batch was subsequently cooled to 60° C., admixed with 6.4 g of anhydrous acetic acid (50% excess) and stirred for 30 minutes at this temperature. 100 ml of toluene were added and the solids fractions were separated using a filter press (K 300 filter disc). The clear filtrate obtained is freed from volatiles on a rotary evaporator at a bath temperature of 70° C. and an applied vacuum of <5 mbar.

A sample of the thus obtained-colorless residue was analyzed by ²⁹Si-NMR spectroscopy. The characteristic signal positions of the accompanying ²⁹Si-NMR spectrum demonstrate that proportions of an SiOH-bearing siloxane were formed in addition to a linear α,ω-diethoxypolydimethylsiloxane.

In direct comparison with example 3, example 4 demonstrates that while the Aerosil increases the selectivity of the siloxane ethoxylation it is by no means sufficient to add an arbitrary silicate—in this case perlite—to improve the selectivity of the siloxane ethoxylation.

1. A process for producing one or more alkoxysiloxanes by reaction of at least one siloxane parent structure with at least one alkali metal alkoxide, the process comprising:
(a) reacting at least one siloxane parent structure by mixing with at least one alkali metal alkoxide with heating and optionally with addition of silicon dioxide but without addition of alcohol and without removal of any potentially occurring water from the reaction mixture and
(b) neutralizing the reaction mixture resulting from the first step (a) by addition of at least one Brønsted acid, optionally with addition of at least one solvent, and preferably separating solid constituents and
(c) subsequently isolating the alkoxysiloxane(s) by thermal separation of volatile compounds,
wherein the at least one siloxane parent structure comprises hexamethylcyclotrisiloxane (D3), octamethylcyclotetrasiloxane (D4), decamethylcyclo-pentasiloxane (D5), dodecamethylcyclohexasiloxane (D6), a mixture of cyclic branched D/T siloxanes, silicone oil, polydimethylsiloxanediol, α,ω-divinylsiloxane, or a mixture thereof.

2. The process of claim 1, wherein the reacting (a) is undertaken without solvents forming azeotropes with water.

3. The process of claim 1, wherein the at least one alkali metal alkoxide is of formula (I):
[M⁺][OR⁻] (I),
wherein
M is Li, Na, or K,
R is an alkyl radical.

4. The process of claim 1, wherein the reacting (a) of the at least one siloxane parent structure is performed with potassium and/or sodium methoxide.

5. The process of claim 1, wherein the reacting (a) is carried out in the presence of pulverulent silicon dioxide.

6. The process of claim 5, wherein the reacting (a) of the at least one siloxane parent structure is performed with potassium and/or sodium ethoxide.

7. The process of claim 1, wherein the reacting (a) is performed solventlessly.

8. The process of claim 1, wherein the reacting (a) is performed in a temperature range of from 100° C. to 200° C., over a period in a range of from 1 to 12 hours.

9. The process of claim 1, wherein the at least one alkali metal alkoxide is employed in a total amount of from 1 to 10 mol. %, based on a total amount of the at least one siloxane parent structure.

10. The process of claim 1, wherein the silicon dioxide is pulverulent and is employed in a total amount in a range of from 1 to 10 mol. %, based on a total amount of the at least one siloxane parent structure.

11. The process of claim 1, wherein the at least one Brønsted acid added in the neutralizing (b) is anhydrous mineral acid and/or anhydrous organic acid.

12. The process of claim 1, comprising the at least one solvent, preferably selected from the group consisting of alkanes and alkylaromatics, is added in the second process step (b).

13. The process of claim 1, which produces α,ω-dimethoxypolydimethylsiloxane and/or for producing α,ω-dieethoxypolydimethylsiloxane.

14. An alkoxysiloxane, obtained the process of claim 1.

15. A polymerization-active mass, comprising the alkoxysiloxane of claim 14.

16. A process for producing one or more SiOC-bonded polyether siloxanes, the process comprising:
transesterifying the alkoxysiloxane of claim 14 with one or more polyetherols in the presence of zinc acetylacetonate as catalyst.

17. The process of claim 1, wherein the reacting (a) is undertaken without water-binding silicic esters, in particular without the use of tetraalkoxysiloxanes.

18. The process of claim 1, wherein the reacting (a) is undertaken without solvents forming azeotropes with water and without water-binding silicic esters, in particular without the use of tetraalkoxysiloxanes.

19. The process of claim 1, wherein, in the at least one alkali metal alkoxide of formula (I), the alkyl radical comprises 1 to 10 carbon atoms.
